(19) United States
(12) Patent Application Publication
(10) Pub. No.: US 2005/0276945 A1
(43) Pub. Date: Dec. 15, 2005

(54) Composite articles and methods of making the same

(76) Inventors: Mark W. Muggli, West St. Paul, MN (US); Brian E. Spiewak, Inver Grove Heights, MN (US); Craig R. Hoff, Corcoran, MN (US); Katherine A. S. Graham, Roseville, MN (US); Kevin J. Doyle, Woodbury, MN (US); Maria P. Dillon, St. Paul, MN (US); Mark J. Williams, Cottage Grove, MN (US); Todd R. Williams, Lake Elmo, MN (US); Travis B. Hoium, Moorhead, MN (US); Matthew J. Michel, St. Paul, MN (US)

Correspondence Address: 3M INNOVATIVE PROPERTIES COMPANY, PO BOX 33427, ST. PAUL, MN, 55133-3427, US

(21) Appl. No.: 10/864,206

(22) Filed: Jun. 9, 2004

(51) Int. Cl. B32B 1/08

(52) U.S. Cl. 428/36.91; 428/119

(57) ABSTRACT

Composite articles having two interlocked different thermoplastic layers, and methods for making the same.

### BACKGROUND

Composite articles such as films and tubing are widely used in industry. For those composite articles such as films that have two layers of different polymeric materials bonded to each other, achieving a sufficient degree of adhesion between the layers to prevent delamination during storage and/or use is a source of constant concern. Delamination is an especially troublesome problem if the two polymeric materials are dissimilar, for example, in the case where one polymeric material is a fluoropolymer and the other is a conventional non-fluorinated organic polymer.

Chemical methods have been used to enhance adhesion between different polymers. One conventional way for chemically enhancing adhesion between dissimilar polymers involves the use of a tie layer. A tie layer is generally a layer of material that exhibits levels of adhesion to both of the dissimilar polymers that are greater than the level of adhesion between the dissimilar polymers if directly bonded to each other.

Physical/chemical methods such as corona treatment have also been used to enhance adhesion between different thermoplastic materials, and, in some cases, dissimilar thermoplastic materials have been mechanically interlocked using dovetail joints.

### SUMMARY

In one aspect, the present invention provides a composite article comprising:
a first polymeric layer having first and second opposed surfaces, the first polymeric layer having a base and a plurality of non-intersecting ribs extending from the base, the base and ribs defining the first surface, wherein at least one rib is an overhanging rib comprising a wall portion having a height and at least one overhang portion defining a maximum overhang width, and wherein, with respect to a cross-sectional plane taken normal to the longitudinal axis of at least one rib, at least one overhanging rib has a rib height of less than or equal to about 0.5 millimeters and a ratio of the maximum overhang width to the height of the wall portion of at least one; and
a second polymeric layer having first and second opposed surfaces disposed on the first polymeric layer, wherein the first surface of the second polymeric layer substantially conforms to the first surface of the first polymeric layer and engages the ribs, and wherein the first and second polymeric layers have different compositions.

In another aspect, the present invention provides a method of making a composite article comprising:
providing a first polymeric layer having first and second opposed surfaces, the first polymeric layer having a base and a plurality of non-intersecting ribs extending from the base, the base and ribs defining the first surface, wherein at least one rib is an overhanging rib comprising a wall portion having a height and at least one overhang portion defining a maximum overhang width, and wherein, with respect to a cross-sectional plane taken normal to the longitudinal axis of at least one rib, at least one overhanging rib has a rib height of less than or equal to about 0.5 millimeters and a ratio of the maximum overhang width to the height of the wall portion of at least one; and
disposing a second polymeric layer having first and second opposed surfaces onto the first polymeric layer, wherein the first surface of the second polymeric layer substantially conforms to the first surface of the first polymeric layer and engages the ribs, and wherein the first and second polymeric layers have different compositions.

Composite articles of the present invention have mechanically interlocking features that typically enhance adhesion between different polymeric materials. Composite articles of the present invention typically exhibit one or more anisotropic properties such as, for example, peel adhesion.

As used herein, the phrases:
“fluoropolymer” means a polymer having at least 10 weight percent fluorine content;
“polymeric layer” refers to a layer comprising at least one polymer;
“substantially conforms to” means intimately contacts at least 75 percent of;
“substantially incompatible” means immiscible in the molten state; and
“thickness” refers to film thickness in the case of films, and to tube wall thickness in the case of tubes.

### BRIEF DESCRIPTION OF THE DRAWING

FIG. 1 is a perspective cut-away view of an exemplary composite film of the present invention;

FIG. 2 is a perspective cut-away view of an exemplary composite tube of the present invention;

FIG. 3 is a cross-sectional schematic view of an exemplary composite film of the present invention;

FIGS. 4A-4F are exemplary surface outlines of the first polymeric layer;

FIG. 5A is a cut-away end view of the profile die insert used in Example 1;

FIG. 5B is a cut-away end view of the profile die insert used in Example 3;

FIG. 6 is a cross-sectional photomicrograph of a composite film prepared in Example 1;

FIG. 7 is a cross-sectional photomicrograph of a composite film prepared in Example 2;

FIG. 8 is a cross-sectional photomicrograph of a composite film prepared in Example 3;

FIG. 9 is a cross-sectional photomicrograph of a composite film prepared in Example 4;

FIG. 10 is a cross-sectional photomicrograph of a composite tube prepared in Example 5;

FIG. 11 is a cross-sectional photomicrograph of a composite tube prepared in Example 6;

FIG. 12 is a cross-sectional photomicrograph of a composite tube prepared in Example 7;

FIG. 13 is a cross-sectional photomicrograph of a composite film prepared in Example 8;

FIG. 14 is a cross-sectional photomicrograph of a composite film prepared in Example 9;

FIG. 15 is a cross-sectional photomicrograph of a composite film prepared in Example 10;

FIG. 16 is a cross-sectional photomicrograph of a composite film prepared in Example 11;

FIG. 17 is a cross-sectional photomicrograph of a composite film prepared in Example 12;

FIG. 18 is a cross-sectional photomicrograph of a composite film prepared in Example 13; and

FIG. 19 is a cross-sectional photomicrograph of a composite tube prepared in Example 14.

### DETAILED DESCRIPTION

Composite articles of the present invention have two polymeric layers (i.e., first and second polymeric layers) interlocked by ribs having overhanging portions. The first and second polymeric layers each have respective first and second surfaces, at least one of which may be a major surface.

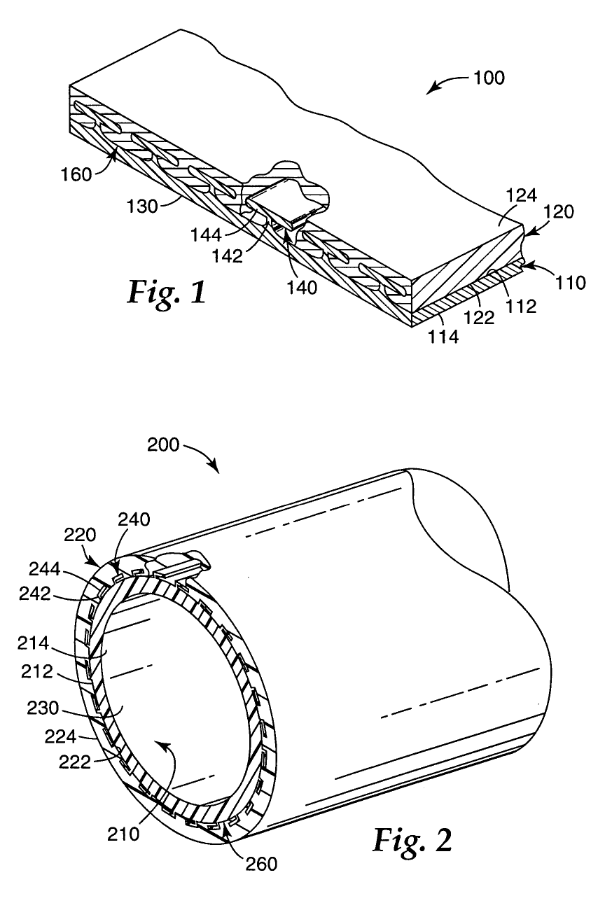

An exemplary composite article is shown in FIG. 1. Referring now to FIG. 1, composite film 100 has first polymeric layer 110 and second polymeric layer 120. First polymeric layer 110 has first and second opposed surfaces 112 and 114, respectively. First surface 112 contacts second polymeric layer 120. First polymeric layer 110 comprises base 130 and a plurality of parallel, linear overhanging ribs 140 that extend from base 130. First surface 112 is defined by base 130 and a plurality of overhanging ribs 140. Each overhanging rib 140 comprises a wall portion 142 and two opposed overhang portions 144.

Second polymeric layer 120 has first and second opposed surfaces 122 and 124, respectively, and is disposed on first polymeric layer 110 such that first surface 122 of second polymeric layer 120 substantially conforms to first surface 112 of first polymeric layer 110 forming surface outline 160 and engaging overhanging ribs 140. First and second polymeric layers 110, 120 comprise first and second polymeric materials, respectively, wherein the first and second polymeric materials are different.

Another exemplary composite article is shown in FIG. 2. Referring now to FIG. 2, composite tube 200 has first polymeric layer 210 and second polymeric layer 220. First polymeric layer 210 has first and second opposed surfaces 212 and 214, respectively. First surface 212 contacts second polymeric layer 220. First polymeric layer 210 comprises base 230 and a plurality of parallel, linear overhanging ribs 240 that extend from base 230. First surface 212 is defined by base 230 and the plurality of overhanging ribs 240. Each overhanging rib 240 comprises a wall portion 242 and one overhang portion 244.

Second polymeric layer 220 has first and second opposed surfaces 222 and 224, respectively, and is disposed on first polymeric layer 210 such that first surface 222 of second polymeric layer 220 substantially conforms to first surface 212 of first polymeric layer 210 forming surface outline 260 and engaging overhanging ribs 240. First and second polymeric layers 210, 220 comprise first and second different polymeric materials.

In order to determine rib height and maximum overhang width at a given point along an overhanging rib, the following procedure is to be used, wherein all lines are straight unless otherwise specified.

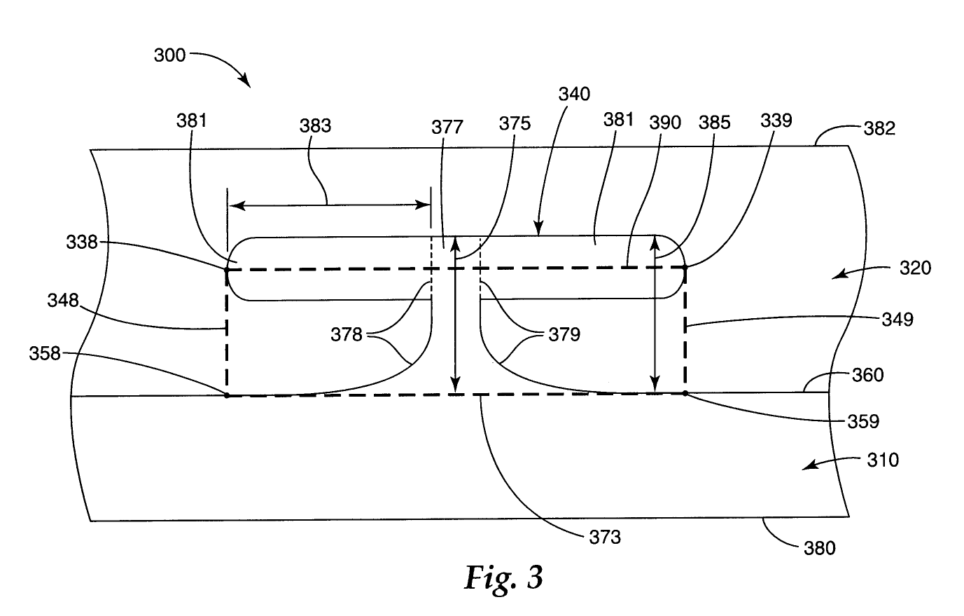

First, as shown for example in FIG. 3, cross-sectional plane 300 is taken through overhanging rib 340 orthogonal to the longitudinal axis, and intersects the first surface (not shown) of the first polymeric layer to form surface outline 360. Similarly, cross-sectional plane 300 cuts through second surfaces (not shown) of first and second polymeric layers 310, 320 to form second edges 380, 382, respectively.

Then, first line 390 is taken parallel to the first edge 380 contacting surface outline 360 at first and second points 338, 339. First line 390 is selected such that the distance between first and second points 338, 339 is maximized. First line 390 may be straight or curved in accordance with first edge 380.

Next, second and third lines 348, 349 are taken perpendicular to line 390 in the direction of first edge 380. Second and third lines 348, 349 intersect surface outline 360 at third and fourth points 358, 359, respectively. In the event, that either or both of second and third lines 348, 349 intersect surface outline 360 at more than one point, third and fourth points 358, 359 are selected so that they are closest to first edge 380. Third and fourth points 358, 359 define horizontal reference line 373. The maximum vertical distance from horizontal reference line 373 to surface outline 360 is referred to hereinafter as rib height 385.

Fourth, with horizontal and vertical directions being thus determined as above, wall portion 377 of overhanging rib 340 is defined as that portion of overhanging rib 340 through which a vertical line can be drawn to the horizontal reference line 373 without crossing surface outline 360. The height of wall portion 375 is the vertical distance from horizontal reference line 373 to the uppermost point within wall portion 377.

The horizontal outer limits of wall portion 377 form first and second wall portion boundaries 378, 379. The remainder of the overhanging rib consists of one or more discrete overhang portions 381. The maximum overhang width 383 is the maximum horizontal distance between surface outline 360 and the closest of first and second wall portion boundaries 378, 379.

In the event that more than one horizontal reference line can be selected according to the above general procedure, the horizontal reference line which results in the greatest value of the maximum overhang width is to be used.

Maximum overhang width and rib height for different ribs may be determined using the same or different cross-sectional planes.

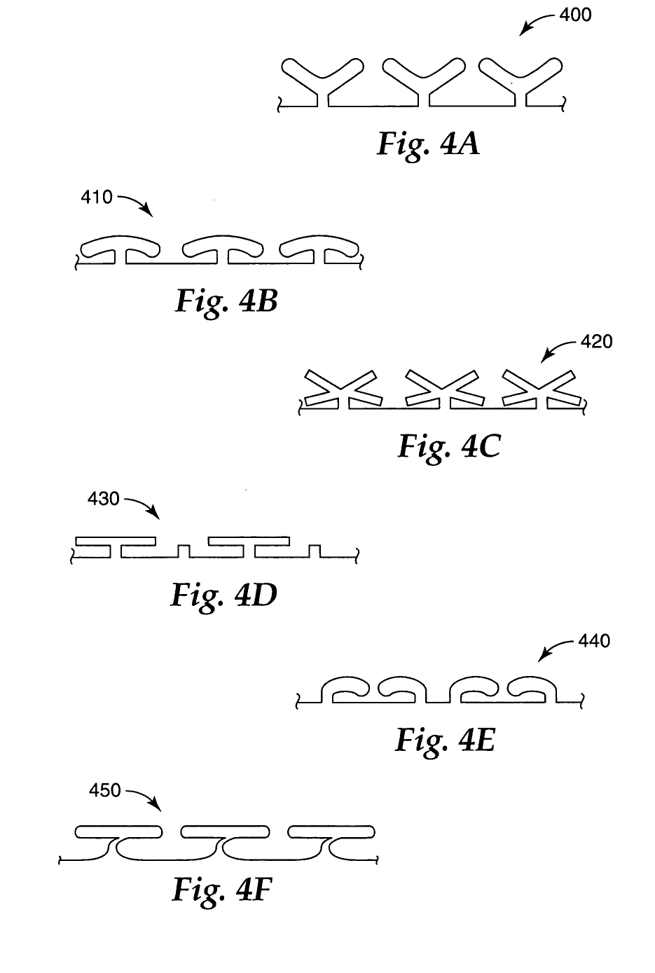

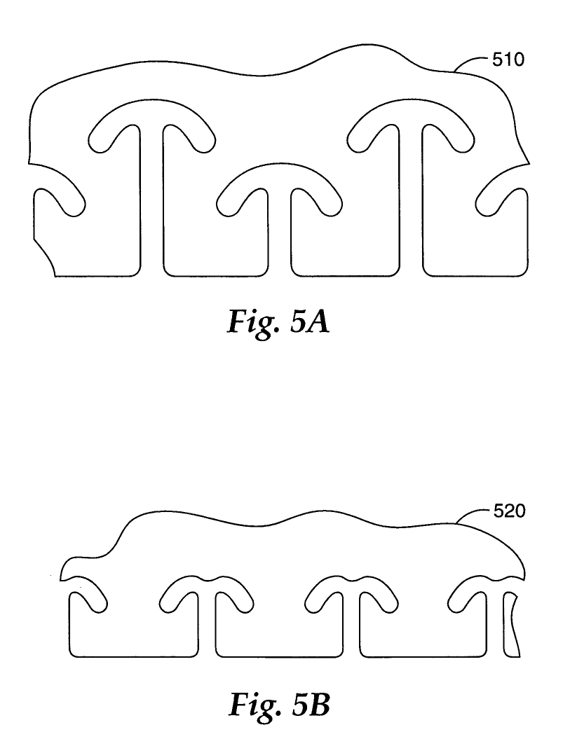

The above general procedure may also be readily carried out for other exemplary surface outlines such, for example, those depicted in FIGS. 4A-4F (i.e., surface outlines 400, 410, 420, 430, 440, and 450, respectively). Of course, other surface outlines such as, for example, resulting from different rib and or base shapes or cross-sectional planes may also be evaluated for rib height and maximum overhang according to the above procedure.

Composite articles of the present invention may be used in applications in which attributes (e.g., cost, physical strength, and/or gas and/or liquid diffusion barrier properties) of the first and/or second thermoplastic layer are important. In such cases, the attribute(s) typically depends on the minimum thickness of the pertinent thermoplastic layer. Generally, in such cases, it is desirable that the ribs have a small height in relation to the overall thickness of the composite article such that maximum and relatively uniform film thickness may be maintained. To achieve this result one or more ribs, for example, substantially all of the ribs, have a height of less than or equal to about 0.5 millimeters, although some of the ribs may be larger in some cases. Further, in those cases in which barrier properties of a polymeric material are relied upon, choosing that polymeric material for the first polymeric layer typically ensures that a minimum thickness is maintained.

Ribs may be overhanging or non-overhanging, provided there is at least one overhanging rib. The number of ribs, overhanging or otherwise, may be relatively large. The number of ribs may be at least 2, 3, 5, 10, 30, 50, 100, 500, 1000 or even more, for example, as in the case of large area films, or the number of ribs may be as few as two, for example, as in the case of very small composite articles.

It will be recognized, that the cross-sectional profile of a rib may vary along its length, for example, by design or due to manufacturing tolerances.

Accordingly, the rib height and maximum overhang width may vary depending on the particular cross-sectional plane chosen.

The ribs are generally non-intersecting and may be continuous or discontinuous. Typically, the ribs are generally parallel in their orientation, although other orientations may also be used. The ribs may be regularly spaced from one another, or the spacing may vary between ribs. For example, the spacing between at least a portion of the ribs may be less than 1, 0.3, or even 0.1 millimeter.

The ribs may have any height, including mixtures of various heights, as long as the foregoing criteria are met. In some embodiments, the height of individual ribs may vary along the length of the rib, although it is generally desirable that some, most, or even all of the ribs have a rib height of less than 100 micrometers. In some embodiments, the ribs may have a rib height of less than about 20, 10, or even less than about 5 percent of the thickness of the composite article. This may be particularly useful for those composite articles intended for use in applications wherein barrier properties of the composite article are important. By using ribs with rib heights that are relatively small compared to the overall thickness of the composite article, it is typically possible to maintain a relatively thick layer of a given polymeric material, while simultaneously achieving benefits due to mechanical interlocking of the first and second polymeric layers of polymeric material.

The ribs may have any elongated shape as long (e.g., straight and/or curvilinear) such that they extend from the base portion of the first polymeric layer. For example, at least some of the ribs may have a cross-sectional outline such as any of those shown, for example, in FIGS. 4A-4F. For example, when viewed in cross-section as described above, an overhanging rib may have one, two, three, four, or even more overhang portions. In some cases, the overhang portions may extend substantially orthogonally to the rib wall (e.g., see FIG. 2). In other cases, with respect to the wall portion, at least one overhang portion may have a distal end and a proximal end, wherein the distal end is not further from the base than the proximal end (e.g., see FIG. 4B).

In one embodiment, the first and second polymeric layers may have regions consisting of different, typically compatible, polymeric materials. For example, the first polymeric layer may have a base portion consisting of one polymeric material, and overhanging ribs of another compatible polymeric material (e.g., as shown in FIGS. 14-19). Alternatively or in addition, the first and/or second polymeric layers may have regions of one polymeric material encased in a second polymeric material (e.g., as in the case of a semi-interpenetrating polymer network).

Due to their ribbed nature, composite articles of the present invention typically exhibit one or more anisotropic properties such as, for example, tear strength and/or peel strength.

The first surface of the second polymeric layer contacts the ribbed first surface of the first polymeric layer such that it at least substantially conforms to the first surface of the first polymeric layer and engages the ribs, thereby affixing the first and second polymeric layers to one another. The second polymeric layer at least substantially conforms (e.g., essentially completely) to the first surface of the first polymeric layer, but deviations from conformance of the second polymeric layer may arise, for example, due to manufacturing tolerances, or by deliberate design.

The first and second polymeric layers may be of any relative thickness, for example, they may of substantially equal average thickness, or they may be of unequal average thickness.

Composite articles according to the present invention may have a thickness of less than or equal to 1000 micrometers, 150 micrometers, 100 micrometers, 50 micrometers, or even less than or equal to 5 micrometers, although the thicknesses outside of this range are also useful.

For many composite articles such as, for example, films and tubes, the second surfaces of the first and second polymeric layers are typically smoother than the first surface of the first polymeric layer.

The first and second polymeric layers comprise different polymeric materials, typically including at least one organic polymer in each layer. The polymeric materials may, for example, be thermoplastic or thermoset. If the polymeric material is at least partially crosslinked (i.e., thermoset), it is typically at least partially crosslinked after formation of the composite article, although the first polymeric layer may be at least partially crosslinked prior to, or coincident with, disposing the second polymeric layer onto the first polymeric layer. In some embodiments, the first and second polymeric materials may be at least substantially incompatible.

Although any polymeric material may be used in practice of the present invention, typically the first and/or second polymeric layers consist of thermoplastic material at some point during manufacture.

Any thermoplastic materials may be used in manufacture of either layer of the composite articles of the present invention. Examples of suitable thermoplastic materials include polyamides and modified polyamides (e.g., nylon-6, nylon-6,6, nylon-11, nylon-6,12, nylon-6,9, nylon-4, nylon-4,2, nylon-4,6, nylon-7, nylon-8, and nylon-12), polyolefins (e.g., homopolymers of polyethylene or propylene), as well as copolymers of these monomers with acrylic monomers and other ethylenically unsaturated monomers such as vinyl acetate and higher alpha-olefins, polyesters, polycarbonates (e.g., polyestercarbonates, polyethercarbonates, and bisphenol A derived polycarbonates), polyurethanes (e.g., aliphatic, cycloaliphatic, aromatic, and polycyclic polyurethanes), polysiloxanes, poly(meth)acrylates (e.g., polymers of acrylic acid, methyl acrylate, ethyl acrylate, acrylamide, methacrylic acid, methyl methacrylate, and/or ethyl methacrylate), polyarylates, polyvinyls, polyethers, cellulosics, polyimides (e.g., polyimide polymers made from the anhydride of pyromellitic acid and 4,4′-diaminodiphenyl ether available from E.I. du Pont de Nemours and Company, Wilmington Del. under the trade designation “KAPTON”), fluoropolymers, polyketones, polyureas, thermoplastic elastomers (e.g., thermoplastic polyurethanes, styrene-butadiene copolymers, styrene-isoprene copolymers), and combinations thereof.

For many applications, including for example, those in which barrier properties are important, at least one of the first and second polymeric materials may comprise, on a total weight basis, at least 20, 30, 40, 50, 60, 70, 80, or 90 weight percent or even more of at least one fluoropolymer.

Useful fluoropolymers may be perfluorinated or only partially fluorinated. Useful fluoropolymers include, for example, those that are preparable (e.g., by free-radical polymerization) from monomers comprising chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl ether) such as CF₃OCF₂CF₂CF₂OCF═CF₂, or a perfluoro(alkyl vinyl ether) such as perfluoro(methyl vinyl ether) or perfluoro(propyl vinyl ether)), cure site monomers such as for example nitrile containing monomers (e.g., CF₂═CFO(CF₂) LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, or CF₂═CFO(CF₂)ᵤOCF(CF₃)CN where L=2-12; q=0-4; r=1-2; y=0-6; t=1-4; and u=2-6), bromine containing monomers (e.g., Z-R_{f}—Oₓ—CF═CF₂, wherein Z is Br or I, R_{f} is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; terpolymers of tetrafluoroethylene, hexafluoropropylene and vinylidene fluoride; copolymers of tetrafluoroethylene, hexafluoropropylene, perfluoropropyl vinyl ether, and vinylidene fluoride; tetrafluoroethylene-hexafluoropropylene copolymers; tetrafluoroethylene-perfluoro(alkyl vinyl ether) copolymers (e.g., tetrafluoroethylene-perfluoro(propyl vinyl ether)); and combinations of thereof.

Useful commercially available fluoropolymers include, for example, those marketed by Dyneon LLC under the trade designations “THV” (e.g., “THV 220”, “THV 400G”, “THV 500G”, “THV 815”, and “THV 610X”), “PVDF”, “PFA”, “HTE”, “ETFE”, and “FEP”; those marketed by Atochem North America, Philadelphia, Pa. under the trade designation “KYNAR” (e.g., “KYNAR 740”); those marketed by Ausimont, USA, Morristown, N.J. under the trade designations “HYLAR” (e.g., “HYLAR 700”) and “HALAR ECTFE”.

The first and second polymeric materials may optionally comprise one or more additional components such as, for example, stabilizers, antioxidants, pigments, plasticizers, UV absorbers, tackifiers, flow control agents, fillers, processing aids, adhesion promoters, colorants, glass bubbles, static control additives (e.g., carbon black), and/or thixotropes.

Composite articles according to the present invention can be made according to a variety of methods. For example, the first and second polymeric layers may be simultaneously coextruded using a profile co-extrusion die, for example, as described in concurrently filed U.S. patent appln. Ser. No. ______ and entitled “MECHANICAL INTERLOCKING DIE” bearing Attorney case No. 59561US002, or U.S. Pat. No. 6,447,875 (Norquist et al.), the disclosures of which are hereby incorporated by reference, optionally with subsequent application of pressure (e.g., by a nip roll) while in the molten state. In this procedure, height of the composite film and the ribs is typically a function of factors including the die design and web stretching that occurs during handling.

In another embodiment, the first polymeric layer may be prepared in separate step(s). For example, the first polymeric layer may be created by a single step process such as profile extrusion, or by a multi-step process by embossing a film or casting molten polymer in a mold to create a layer having non-overhanging ribs on one surface, followed by exposing the ribbed surface to external energy (e.g., an air knife, infrared radiation, contact with a heated roll or platen) to form them into overhanging ribs. If desired, discontinuous ribs may be formed, for example, by extruding a layer of thermoplastic material having ribs, slitting the ribs cross-wise to their length, and stretching the layer along their length (e.g., using a wind up roll).

In another embodiment, the first polymeric layer may be created by bonding a thermoplastic scrim having non-intersecting overhanging ribs to a film or tubular base. In this embodiment, the scrim may be, for example, of the same material of the base, or a different material that is bondable to the base, for example, by heating, adhesive, or application of radiant or ultrasonic energy.

In some cases, the first polymeric layer may be prepared in single step of casting molten polymer into a mold with undercut regions to create, upon removal from the mold, a layer having non-intersecting overhanging ribs on one surface.

The second polymeric layer is then applied to the ribbed surface (i.e. first surface) of the first polymeric layer. Useful methods for applying the second polymeric layer include, for example, solvent casting, powder coating, and extrusion methods.

Additional process steps such as, for example, calendering, embossing, stretching may also be used in combination with the above procedures.

Optionally, the composite article may be subjected to additional treatments that at least partially crosslink the first and/or second polymeric layers. Examples of such treatments include heating, especially if the first and/or second polymeric layer further comprises a thermal crosslinking agent, and ultraviolet and/or electron beam radiation. Further details concerning crosslinking of polymeric materials may be found in, for example, U.S. Pat. No. 6,652,943 (Tukachinsky et al.), the disclosure of which is incorporated herein by reference, and PCT Patent Publication WO 200196487 A 1 (Suwa et al.).

Composite articles according to the present invention may have many useful forms including, for example, tubes (including hoses and pipes), blow molded articles (including bottles and bags), injection molded articles, and films (including sheets and rolls). Specific examples include fuel hoses, protective films, and fuel tank liners.

Objects and advantages of this invention are further illustrated by the following non-limiting examples, but the particular materials and amounts thereof recited in these examples, as well as other conditions and details, should not be construed to unduly limit this invention.

### EXAMPLES

All parts, percentages, ratios, etc. in the examples and the rest of the specification are by weight, unless noted otherwise.

Unless otherwise noted, all reagents used in the examples were obtained, or are available, from general chemical suppliers such as, for example, Sigma-Aldrich Company, Saint Louis, Mo., or may be synthesized by conventional methods.

The following abbreviations are used throughout the following examples

| ABBREVIATION | DESCRIPTION |
|---|---|
| EA | acid modified ethylene acrylate, available under |
| | the trade designation “BYNEL 2002” from E.I. du |
| | Pont de Nemours & Company, Wilmington, |
| | Delaware |
| EMA | ethylene-methacrylic acid copolymer, available |
| | under the trade designation “NUCREL 1202 HC” |
| | from E.I. du Pont de Nemours & Company |
| FP1 | terpolymer of tetrafluoroethylene, |
| | hexafluoropropylene, and ethylene available under |
| | the trade designation “DYNEON THV 200”, from |
| | Dyneon LLC, Oakdale, Minnesota |
| FP2 | terpolymer of tetrafluoroethylene, |
| | hexafluoropropylene and ethylene available under |
| | the trade designation “DYNEON THV 500”, from |
| | Dyneon LLC |
| FP3 | a copolymer of tetrafluoroethylene, |
| | hexafluoropropylene, vinylidene fluoride, and |
| | perfluoropropyl vinyl ether, available under the |
| | trade designation “DYNEON THV 815” from |
| | Dyneon, LLC |
| FP4 | copolymer of tetrafluoroethylene, |
| | hexafluoropropylene, vinylidene fluoride and |
| | perfluoropropyl vinyl ether, Tₘ = 230° C., |
| | available under the trade designation “VFEPX |
| | 6815G” from Dyneon, LLC |
| NY1 | nylon 6, available under the trade designation |
| | “ULTRAMID B3” from BASF, Ludwigshafen, |
| | Germany |
| NY2 | polyamide, available under the trade designation |
| | “NYCOA 2011” from Nycoa, Manchester, New |
| | Hampshire |
| NY3 | nylon 12, available under the trade designation |
| | “GRILAMID L25 W40X” from EMS Chemie, |
| | Domat, Switzerland |
| PB | maleic anhydride grafted polypropylene, available |
| | under the trade designation “POLYBOND 3002” |
| | from Crompton Corporation, Middlebury, |
| | Connecticut |
| PE1 | high density polyethylene, available under the |
| | trade designation “FORTIFLEX B53-35H-100” |
| | from BP Solvay Polyethylene NA, Houston, Texas |
| PE2 | high density polyethylene, available under the |
| | trade designation “HDPE 10462N” from Dow |
| | Chemical Company, Midland, Michigan |
| PP1 | polypropylene, available under the trade |
| | designation “ATOFINA POLYPROPYLENE |
| | 3271” from Atofina, Paris, France |
| PP2 | a copolyester, available under the trade |
| | designation “EASTAR POLYESTER 6763” from |
| | Eastman Chemical Company, Kingsport, |
| | Tennessee |
| PP3 | polypropylene, available under the trade |
| | designation “PP 7644” from BP Amoco Chemical |
| | Company, Naperville, Illinois |
| PP4 | polypropylene, available under the trade |
| | designation “PP 1024” from ExxonMobil |
| | Corporation, Houston, Texas |
| PP5 | polypropylene, obtained under the trade |
| | designation “UC 7C55” from Union Carbide Corp. |
| | Danbury, Connecticut |
| PS | polystyrene, available under the trade designation |
| | “PS G18” from Huntsman Polymers Corporation, |
| | Houston, Texas |

The following abbreviations are used throughout the examples: m=meter, cm=centimeter, mm=millimeter, min=minute, g=grams, rpm=revolutions per minute, psi=pounds per square inch, MPa=megaPascals, and kPa=kiloPascals.

Peel Strength Test

A strip of the specimen to be tested, 0.5-inch (1.3-cm) wide and at least 1 inch (2.5 cm) in length, is prepared. In the case of a tube specimen, the tube is slit along its length prior to preparing the strip.

A crack (1.3 cm minimum length) is initiated between the layers between which peel strength is to be measured.

Each layer is placed in an opposed clamp of an Instron Tensile Tester (model 5564) obtained from Instron Corporation, Canton, Mass.

Peel strength is measured at a crosshead speed of 150 mm/min as the average load for separation of the two layers. In some cases maximum loads observed during peel are also reported. The value reported for maximum load is either the highest load during the test or the peak force before the sample breaks. “Rib direction” refers to longitudinal direction of the ribs. “Cross direction” means orthogonal to the rib direction.

Reported peel strengths represent an average of at least four samples.

### Example 1

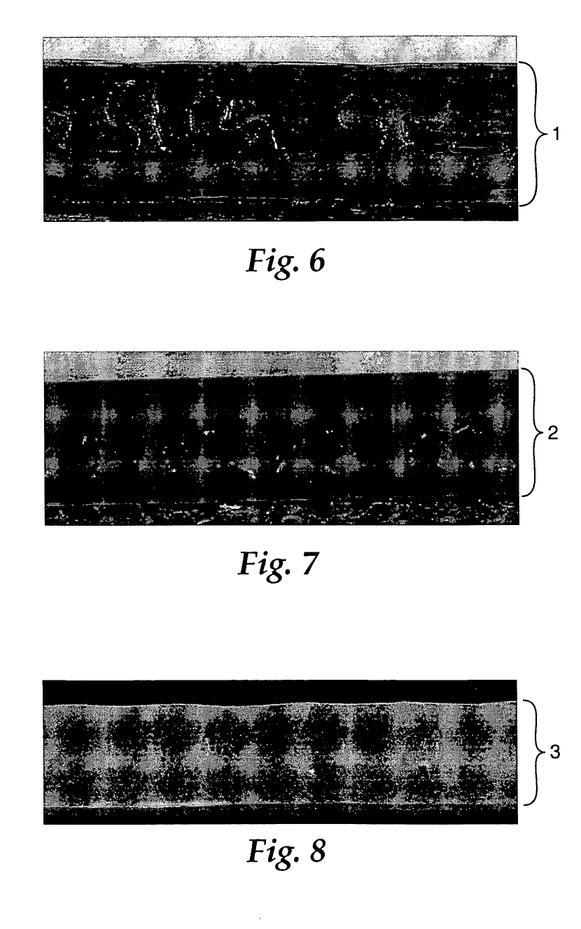

FP2 was extruded using a 2.5″ Davis single-screw extruder (Davis—Standard, Pawcatuck, Conn.) with a temperature profile of zone 1=246° C.; zone 2=274° C.; zone 3=279° C.; zone 4=279° C. and a screw speed of 15 rpm through an 8-inch (20-cm) film die available under the trade designation “MASTERFLEX LD-40 FILM DIE” from Cloeren, Inc., Orange, Tex. that was equipped with a profile die insert 510 shown in FIG. 5A. The die temperature was 279° C. The length of the profile die insert was 20.3 cm, and there were 151 features in the die insert, with a separation of 1.2 mm from the midpoint of one feature to the other. Molten FP2 was extruded as a film at 10 feet per minute (3.0 m/min) with a basis weight of 885 g/m² and quenched in a water bath and then fed through web handling equipment and wound up at a wind-up station. The film was passed between a backup roll and casting roll (set at 200° F. (93° C.)), spaced at 20 mils (500 micrometers) gap and with a nip pressure of 10 psi (70 kPa). A melt curtain of NY1 was cast into the nip point using a 14-inch film die available under the trade designation “EBR” from Cloeren, Inc. This film die was also fed using the same model single-screw extruder with a temperature profile of zone 1=410° F. (204° C.), zone 2=430° F. (221° C.), zone 3=450° F. (232° C.), zone 4=470° F. (243° C.), and a die temperature of 470° F. (243° C.). At the nip point the NY1 was molten and had sufficiently low viscosity that it flowed around and underneath the FP2 film profiles. The line speed through the nip rolls was 5 feet per minute (1.5 m/min), A cross-sectional photomicrograph, taken orthogonal to the longitudinal axis of the ribs of the resultant two-layer composite film 1 is shown in FIG. 6. The composite film had an average composite film thickness of 1.1 mm.

### Example 2

The procedure of Example 1 was repeated, except that NY2 was used instead of NY1, PP1 was used instead of FP2; the temperature profile for the PP1 extrusion ranged from 177° C. in zone 1 to 232° C. in zone 4, the screw speed was 22 rpm, the die temperature was 232° C., and the basis weight of this film was 361 g/m²; and the temperature profile for extruding NY2 was zone 1=420° F. (216° C.), zone 2=435° F. (224° C.), zone 3=460° F. (238° C.), zone 4=475° F. (246° C.). A cross-sectional photomicrograph, taken orthogonal to the longitudinal axis of the ribs of the resultant two-layer composite film 2 is shown in FIG. 7. The composite film had an average composite film thickness of 1.4 mm.

### Example 3

The procedure of Example 1 was repeated, except that PE1 was used instead of NY2, PP5 was used instead of FP2, and the following changes were also made. A profile die insert 520 as shown in FIG. 5B, having a length of 20.3 cm, and with 129 features at a midpoint separation of 1.3 mm was used. Extrusion temperatures of PP5 were identical to those of PP1. The basis weight of the film was 311 g/m². PE1 was extruded with a temperature profile of zone 1=191° C.; zone 2=204° C.; zone 3=218° C.; zone 4=232° C.) and a die temperature of 232° C. A cross-sectional photomicrograph, taken orthogonal to the longitudinal axis of the ribs of the resultant two-layer composite film 3 is shown in FIG. 8. The composite film had an average composite film thickness of 1.3 mm.

### Example 4

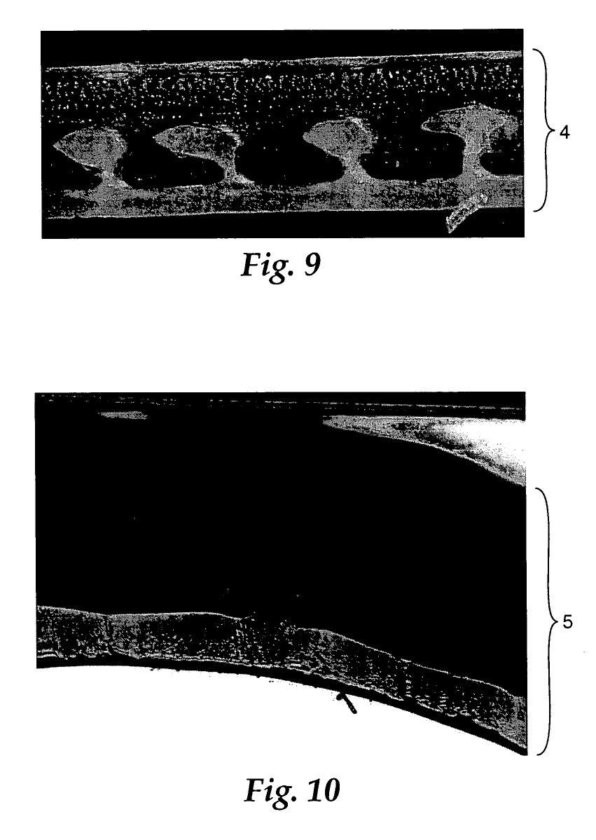

The procedure of Example 3 was repeated, except that PP2 was used instead of PE1, and the PP2 was extruded with a temperature profile of zone I=241° C.; zone 2=241° C.; zone 3=241° C.; zone 4=241° C.) and a die temperature of 241° C. A cross-sectional photomicrograph, taken orthogonal to the longitudinal axis of the ribs of the resultant two-layer composite film 4 is shown in FIG. 9. The composite film had an average composite film thickness of 1.3 mm.

Results of PEEL TEST measurements on the composite films of Examples 1-4 are presented in Table 1 (below).

TABLE 1

| | | | 180° Peel Strength |
|---|---|---|---|
| | | | in Rib direction, |
| Example | Profiled film | Cover material | Newtons/cm |
| 1 | FP2 | NY1 | 17.3 |
| 2 | PP1 | NY2 | 17 |
| 3 | PP1 | PE1 | Could not |
| | | | delaminate sample |
| 4 | PP1 | PP2 | 39.4 |

### Example 5

Example 5 was a composite tube having three layers: the first layer was FP3, the second layer was NY3, and the third layer is NY3. It was prepared using a Guill model 523 (Guill Tool and Engineering Co., Inc., West Warwick, R.I.) three-layer in-line extrusion head, using the wedge ring shown in FIG. 1 of concurrently filed U.S. patet appln. Ser. No. ______ and entitled “MECHANICAL INTERLOCKING DIE” bearing Attorney case No. 59561US002 (central aperture diameter of 0.76 inches) and a straight pin of outside diameter 0.690 inches.

The second layer was extruded onto the first layer while it was still in the extrusion tooling. Subsequently, the third layer was coated onto the second layer, also within the extrusion head, such that when the tube exited the extrusion head, it had a FP3 first layer, NY3 second layer, and NY3 third layer. To form the first layer, FP3 was extruded using a 1.5-inch (3.8 cm) single-screw extruder available from Harrel, Inc. of East Norwalk, Conn. (Temp Profile: zone 1=255° C., zone 2=275° C., zone 3=285° C.). The second layer was extruded onto the first layer while it was still within the extrusion head using a 1.0-inch (2.5-cm) single-screw extruder available from Harrel, Inc. (Temp Profile: zone 1=180° C., zone 2=200° C., zone 3=200° C.). Next the third layer was extruded onto the second layer while it was still within the extrusion head using a 2.0-inch (5.1-cm) single-screw extruder available from Harrel, Inc. (Temp Profile: zone 1=180° C., zone 2=195° C., zone 3=210° C., zone 4=210° C.). The extrudate exited a tube die having a die opening was 0.866 inches (2.20 cm) at a line speed of 11.6 feet/minute (3.54 m/min) and was quenched using a vacuum water chamber. A cross-sectional photomicrograph, taken orthogonal to the longitudinal axis of the ribs of the resultant composite tube 5, is shown in FIG. 10. The nominal inner diameter of the tube was 6 mm and a nominal outer diameter was 8 mm.

### Example 6

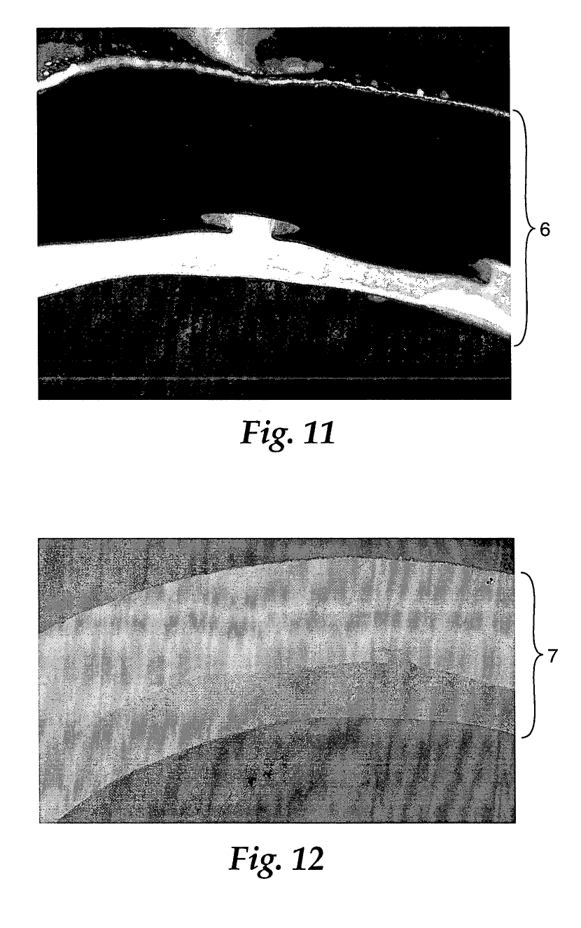

The procedure of Example 5 was repeated, except that FP4 was used instead of FP3. In this Example the line speed was 52 fpm (16 n/min). A cross-sectional photomicrograph, taken orthogonal to the longitudinal axis of the ribs of the resultant composite tube 6, is shown in FIG. 11. The nominal inner diameter of the tube was 6 mm and a nominal outer diameter was 8 mm.

### Example 7

The procedure of Example 6 was repeated, except that PB was used instead of NY3, PE1 was used instead of NY3 and the pin outside diameter was 0.642 inches. The PB was extruded using a 1-inch Harrel single-screw extruder (temperature profile: zone 1=200° C., zone 2=220° C., zone 3=220° C.), and the PE1 was extruded using a 2.0-inch (5.1-cm) Harrel single-screw extruder (temperature profile: zone 1=185° C., zone 2=200° C., zone 3=210° C., zone 4=210° C.). The line speed was 20 fpm (6.0 m/min). A cross-sectional photomicrograph, taken orthogonal to the longitudinal axis of the ribs of the resultant composite tube 7, is shown in FIG. 12. The composite tube had the same diameter and wall thickness as Example 6.

TABLE 2

| | Peel Strength in Rib Direction, |
|---|---|
| Example | Newtons/cm |
| 5 | 13.9 |
| 6 | 15.6 |
| 7 | 4.4 |

### Example 8

An extrusion was carried out using a 45-cm width Cloeren two-layer multi-manifold die (available from Cloeren Co., Orange, Tex.) that had been modified. The vane had been hollowed out according to U.S. Pat. No. 6,447,875 (Norquist et al.), except that the vane tip, which had ninety-five orifices, was fabricated and mounted to the vane manifold with a number of small socket head bolts. The ninety-five orifices were spaced across the vane tip, each having circular cross-sectional shape with a diameter of 0.15 mm and a spacing between orifices of 3.4 mm. The length of these orifices was 6 mm.

The material for the thicker outer layer, EA, was fed with an extruder (2-inch (51 mm)) single-screw extruder available from Berlyn Extruders, Inc., Worcester, Mass. This extruder was operated at an output of 14.5 kg/hr and a head pressure of 8 MPa. The EA was fed to the main cavity of the modified die. This layer is the thicker of the two outer layers in the film construction. The material for the thinner outer layer, FP2, was fed with a 25 mm twin-screw extruder (available from Werner-Pfleiderer Corporation, Ramsey, N.J.) at 150 rpm and 9 kg/hr, a gear pump was used to meter the material, where the gear pump was run at 14.2 rpm to create a pressure of 340 psi. FP2 was fed to the main cavity of the modified die. The included layer, FP1 (also containing 1 percent by weight of a colorant) was fed by a 1.25-inch (3.18 cm) single-screw extruder (having the trade designation “KILLION”, available from Davis-Standard; Pawcatuck, Conn.) through the modified vane in the die. The extruder for the included layer was operated at 20 rpm and a pressure of 17.9 MPa to feed at a rate of 3.6 kg/hr. The Berlyn extruder was operated with the following temperature profile: zone 1=193° C., zone 2=204° C., zones 3-7=216° C. The twin-screw extruder was operated with the following temperature profile: zone 1=204° C., zone 2=221° C., zone 3=232° C., zones 4-9=243° C. The Killion extruder was operated with the following temperature profile: zone 1=227° C., zones 2-3=243° C. The die was operated at 260° C. The extrudate, which was a two-layer film containing an included layer running down-web, was extruded from the die into a nip formed by a chrome plate casting wheel at 15.6° C. and a silicone coated nip roll at 4.4° C. The web handling system was operated at 2.3 m/min.

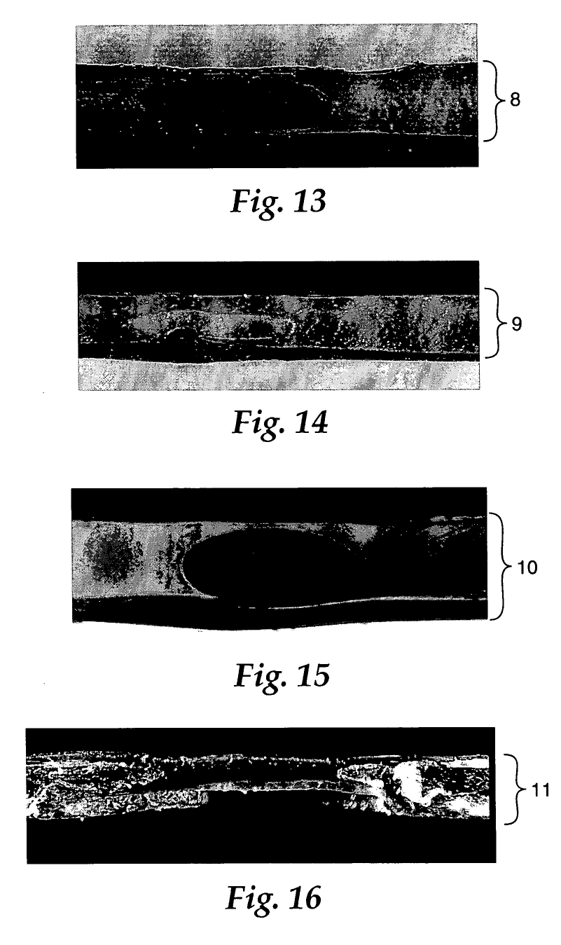

A cross-sectional photomicrograph, taken orthogonal to the longitudinal axis of the ribs of the resultant composite film 8, is shown in FIG. 13. The film had a total thickness of 14 mils (0.36 mm).

### Example 9

The procedure of Example 8 was repeated, except that EA was replaced with EMA. A cross-sectional photomicrograph, taken orthogonal to the longitudinal axis of the ribs of the resultant composite film 9, is shown in FIG. 14. The film had a total thickness of 16 mils (0.41 mm).

### Example 10

The procedure of Example 9 was repeated, except that FP1 was replaced with FP2 (containing 1 percent by weight colorant). A cross-sectional photomicrograph, taken orthogonal to the longitudinal axis of the ribs of the resultant composite film 10, is shown in FIG. 15. The film had a total thickness of 16 mils (0.41 mm).

### Comparative Example A

The procedure of Example 8 was repeated with the following changes: EA was fed with the twin-screw extruder at 250 rpm, 4.5 kg/hr and the gear pump was run at 11.4 rpm. FP2 was extruded via the Berlyn single-screw extruder at 16 rpm. There was no included layer. The twin-screw extruder was operated with the following temperature profile: zone 1=177° C., zone 2=193° C., zone 3=204° C., zones 4-9=216° C. The Berlyn extruder was operated with the following temperature profile: zone 1=249° C., zone 2=260° C., zones 3-7=288° C. The die was operated at 216° C. The extrudate, which was a two-layer film containing an included layer running down-web, was extruded from the die into a nip formed by a chrome plate casting wheel at 49° C. and a silicone coated nip roll at 4.4° C. The web handling system was operated at 2.3 r/min.

The resultant film had a total thickness of 26 mils (0.66 mm).

### Comparative Example B

The procedure of Example 10 was repeated with the following changes: EMA was fed with the twin-screw extruder at 250 rpm, 2.3 kg/hr. FP2 was extruded via the Berlyn single-screw extruder at 16 rpm. There was no included layer. The twin-screw extruder was operated with the following temperature profile: zone 1=177° C., zone 2=193° C., zone 3=204° C., zones 4-9=216° C. The Berlyn extruder was operated with the following temperature profile: zone 1=249° C., zone 2=260° C., zones 3-7=288° C. The line speed was operated 1.2 n/min.

The resultant film had a total thickness of 16 mils (0.41 mm).

### Example 11

The procedure of Example 8 was repeated with the following changes: PP3 was fed with the twin-screw extruder at 250 rpm, 4.5 kg/hr. PS was extruded via the Berlyn single-screw extruder at 32 rpm. The included layer, PP3 (also containing 2 percent by weight of a colorant) was fed by a 1.24-inch (3.18-cm) single-screw extruder at 3.6 kg/hr. The twin-screw extruder was operated with the following temperature profile: zone 1=177° C., zone 2=193° C., zone 3=204° C., zones 4-9=216° C. The Berlyn extruder was operated with the following temperature profile: zone 1=193° C., zone 2=216° C., zones 3-7=232° C. The Killion extruder was operated with the following temperature profile: zone 1=193° C., zone 2=204° C., zone 3=216° C. The die was operated at 216° C. The extrudate, which was a two-layer film containing an included layer running down-web, was extruded from the die into a nip formed by a chrome plate casting wheel at 49° C. and a silicone coated nip roll at 4.4° C. The line speed was operated 3.7 m/min.

A cross-sectional photomicrograph, taken orthogonal to the longitudinal axis of the ribs of the resultant composite film 11, is shown in FIG. 16. The composite film had a total thickness of 16 mils (0.41 mm).

### Comparative Example C

The procedure of Example 11 was repeated with the following changes: PP3 was fed with the twin-screw extruder at 250 rpm, 9.1 kg/hr. PS was extruded via the Berlyn extruder at 14.5 kg/hr. There was no included layer. The line speed was operated 3.1 m/min.

The resultant film had a total thickness of 13 mils (0.33 mm).

### Example 12

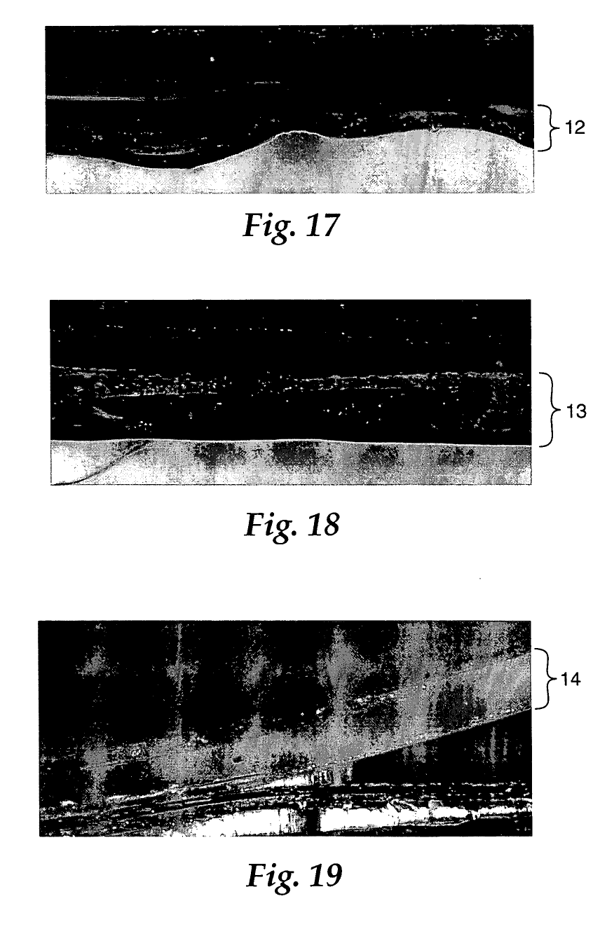

The procedure of Example 8 was repeated with the following changes: PP4 was fed with the twin-screw extruder at 250 rpm, 9.1 kg/hr. PE2 was extruded via the Berlyn single-screw extruder at 32 rpm. The included layer, PP4 (also containing 2 percent by weight of an orange colorant) was fed by a 1.25-inch (3.18-cm) single-screw extruder (Killion) at 3.6 kg/hr. The twin-screw extruder was operated at the following temperature profile zone 1=177° C., zone 2=193° C., zone 3=204° C., zones 4-9=216° C. The Berlyn extruder was operated with zone 1-193° C., zones 2-7=216° C. The Killion extruder was operated at zone 1=193° C., zone 2=204° C., zone 3=216° C. The die was operated at 216° C. The extrudate, which was a two-layer film containing an included layer running down-web, was extruded from the die into a nip formed by a chrome plate casting wheel at 49° C. and a silicone coated nip roll at 4.4° C. The line speed was operated at 3.7 m/min. A cross-sectional photomicrograph, taken orthogonal to the longitudinal axis of the ribs of the resultant composite film 12, is shown in FIG. 17. The film had a total thickness of 22 mils (0.56 mm).

### Comparative Example D

The procedure of Example 12 was repeated, except that the line speed was operated at 2.7 m/min, and there was no included layer. The resultant film had a total thickness of 16 mils (0.41 mm).

### Comparative Example E

The procedure of Comparative Example D was repeated with the following changes: except that PS was extruded via the Berlyn single-screw extruder at 14.5 kg/hr. The Berlyn single-screw extruder was operated with zone 1=204° C., zone 2=216° C., zones 3-7=232° C., and the die was at 232° C. There was no included layer. The line speed was operated at 3.2 m/min. The resultant film had a total thickness of 13 mils (0.33 mm).

### Example 13

The procedure of Example 12 was repeated with the following changes: PP4 was fed with the twin-screw extruder at 4.5 kg/hr and PS was extruded via the Berlyn single-screw extruder at 19.5 kg/hr. The Berlyn extruder was operated with zone 1=204° C., zone 2=216° C., zones 3-7=232° C., and the die was at 232° C. The extrudate was a two-layer film containing an included layer running down-web. The line speed was operated at 3.5 m/min. A cross-sectional photomicrograph, taken orthogonal to the longitudinal axis of the ribs of the resultant composite film 13, is shown in FIG. 18. The film had a total thickness of 15 mills (0.38 mm).

Table 3 (below) reports peel strengths of Examples 8-13 and Comparative Examples A-Z. In Table 3, “NM” means not measured.

TABLE 3

| | Peel Strength in | |
|---|---|---|
| | Cross Direction, | Peak load, |
| Example | Newtons/cm | Newtons/cm |
| 8 | 1.7 | 3.3 |
| 9 | 2.9 | 6.7 |
| 10 | 2.1 | 6.2 |
| Comparative | 0.4 | 0.7 |
| Example A | | |
| Comparative | 0.4 | 0.7 |
| Example B | | |
| 11 | Break | NM |
| Comparative | 0 | 0 |
| Example C | | |
| 12 | Break | NM |
| Comparative | 1.3 | 4.8 |
| Example D | | |
| Comparative | 0 | 0 |
| Example E | | |
| 13 | Break | NM |

### Example 14

The procedure of Example 5 was repeated with the following changes: The straight pin had an outside diameter 0.642 inches (1.63 mm). FP2 was used instead of FP3 for the first layer. The temperature profile of the 1.5-inch (3.8 cm) single screw extruder used to extrude the first layer was: zone 1=230° C., zone 2=245° C., zone 3=255° C.). The temperature profile of the 1.0-inch (2.5-cm) single screw extruder used to extrude the second layer was: zone 1=185° C., zone 2=205° C., zone 3=210° C.). The temperature profile of the 2.0-inch (5.1-cm) single screw extruder was: zone 1=190° C., zone 2=210° C., zone 3=220° C., zone 4=220° C.). The extrudate exited the tube die at a line speed of 11.2 feet/min (3.5 m/min).

The extrudate was passed through a metal tube having an inner diameter of 2 inches (5 cm) after exiting the extrusion die. The extrudate tube was pinched closed and air was supplied to the interior of the extrudate tube at a rate of 0.25 cubic feet per minute (7.1 liters/min) and a pressure of 12 psi (83 kPa) to expand the extruded tube to the inside diameter of the pipe. While in the metal tube, the molten extrudate (in tube form) was quenched in water, and the resultant composite tube was removed from the metal tube. The resultant composite tube had an inner diameter of 1.95 inches (4.95 cm) and a wall thickness of 0.014-0.020 inch (0.35-0.51 mm). A cross-sectional photomicrograph taken orthogonal to the longitudinal axis of the ribs of the resultant composite tube 14, is shown in FIG. 19.

Various modifications and alterations of this invention may be made by those skilled in the art without departing from the scope and spirit of this invention, and it should be understood that this invention is not to be unduly limited to the illustrative embodiments set forth herein.

1. A composite article comprising:
a first polymeric layer having first and second opposed surfaces, the first polymeric layer having a base and a plurality of non-intersecting ribs extending from the base, the base and ribs defining the first surface, wherein at least one rib is an overhanging rib comprising a wall portion having a height and at least one overhang portion defining a maximum overhang width, and wherein, with respect to a cross-sectional plane taken normal to the longitudinal axis of at least one rib, at least one overhanging rib has a rib height of less than or equal to about 0.5 millimeters and a ratio of the maximum overhang width to the height of the wall portion of at least one; and
a second polymeric layer having first and second opposed surfaces disposed on the first polymeric layer, wherein the first surface of the second polymeric layer substantially conforms to the first surface of the first polymeric layer and engages the ribs, and wherein the first and second polymeric layers have different compositions.

2. A composite article according to claim 1, wherein at least one of the first or second polymeric layers is thermoplastic.

3. A composite article according to claim 1, wherein at least one of the first or second polymeric layers is at least partially crosslinked.

4. A composite article according to claim 1, wherein the ribs are continuous.

5. A composite article according to claim 1, wherein the ribs are parallel.

6. A composite article according to claim 1, wherein the ribs have a rib height of less than about 100 micrometers.

7. A composite article according to claim 1, wherein with respect to the cross-sectional plane the composite article has a thickness, and wherein said at least one rib has a height that is less than or equal to 20 percent of the thickness of the composite article.

8. A composite article according to claim 1, wherein with respect to the cross-sectional plane the composite article has a thickness, and wherein said at least one rib has a height that is less than or equal to 10 percent of the thickness of the composite article.

9. A composite article according to claim 1, wherein the first and second polymeric materials are at least substantially incompatible.

10. A composite article according to claim 1, wherein at least one of first and second plastic materials comprises at least one polyamide, polyolefin, polyester, polyimide, or a combination thereof.

11. A composite article according to claim 1, wherein at least one of the first or second polymeric layers comprises at least 20 weight percent of at least one fluoropolymer.

12. A composite article according to claim 11, wherein the fluoropolymer is preparable from monomers comprising chlorotrifluoroethylene, vinylidene difluoride, tetrafluoroethylene, hexafluoropropylene, perfluoro(methyl vinyl ether), perfluoro(propyl vinyl ether), vinyl fluoride, or a combination thereof.

13. A composite article according to claim 12, wherein one of the first and second polymeric materials comprises at least 20 weight percent of at least one fluoropolymer and the other polymeric material comprises at least one polyamide, polyolefin, polyester, polyimide, or a combination thereof.

14. A composite article according to claim 1, wherein the ribs are curvilinear.

15. A composite article according to claim 1, wherein the ribs are regularly spaced.

16. A composite article according to claim 13, wherein the spacing is less than about one millimeter.

17. A composite article according to claim 1, wherein the second surface of the first and second polymeric layers are smoother than the first surface of the first polymeric layer.

18. A composite article according to claim 17, wherein the composite article comprises a tube or a film.

19. A composite article according to claim 1, wherein at least one overhang portion is substantially orthogonal to the wall portion.

20. A composite article according to claim 1, wherein at least a portion of one rib has at least two overhang portions.

21. A composite article according to claim 1, wherein, relative to the wall portion, at least one overhang portion has a distal end and a proximal end, and wherein the distal end is not further from the base than the proximal end.

22. A composite article according to claim 21, wherein the ribs have a rib height of less than about 100 micrometers.

23. A composite article according to claim 21, wherein with respect to the cross-sectional plane the composite article has a thickness, and wherein said at least one rib has a height that is less than or equal to 20 percent of the thickness of the composite article.

24. A composite article according to claim 21, wherein with respect to the cross-sectional plane the composite article has a thickness, and wherein said at least one rib has a height that is less than or equal to 10 percent of the thickness of the composite article.

25. A composite article according to claim 21, wherein the first and second polymeric materials are at least substantially incompatible.

26. A composite article according to claim 21, wherein at least one of the first or second polymeric layers comprises at least 20 weight percent of at least one fluoropolymer.

27. A method of making a composite article comprising:
providing a first polymeric layer having first and second opposed surfaces, the first polymeric layer having a base and a plurality of non-intersecting ribs extending from the base, the base and ribs defining the first surface, wherein at least one rib is an overhanging rib comprising a wall portion having a height and at least one overhang portion defining a maximum overhang width, and wherein, with respect to a cross-sectional plane taken normal to the longitudinal axis of at least one rib, at least one overhanging rib has a rib height of less than or equal to about 0.5 millimeters and a ratio of the maximum overhang width to the height of the wall portion of at least one; and
disposing a second polymeric layer having first and second opposed surfaces onto the first polymeric layer, wherein the first surface of the second polymeric layer substantially conforms to the first surface of the first polymeric layer and engages the ribs, and wherein the first and second polymeric layers have different compositions.

28. A method according to claim 27, further comprising at least partially crosslinking at least one of the first or second polymeric layers.

29. A method according to claim 27, wherein one of the first or second polymeric layers comprises at least 20 weight percent of at least one fluoropolymer.

30. A method according to claim 27, wherein the fluoropolymer is preparable from monomers comprising chlorotrifluoroethylene, vinylidene difluoride, tetrafluoroethylene, hexafluoropropylene, perfluoro(methyl vinyl ether), perfluoro(propyl vinyl ether), vinyl fluoride, or a combination thereof.

31. A method according to claim 27, wherein one of the first or second polymeric layers comprises at least one fluoropolymer and the other polymeric layer comprises at least one polyamide, polyolefin, polyester, polyimide, or a combination thereof.

32. A method according to claim 27, wherein one overhang portion extends from the wall portion.

33. A method according to claim 27, wherein at least two overhang portions extend from the wall portion.

34. A method according to claim 27, wherein, relative to the wall portion, the overhang portion has a distal end and a proximal end, and wherein the distal end is closer to the first surface of the first polymeric layer than the proximal end.

35. A method according to claim 27, wherein the first or second polymeric layers are thermoplastic, and wherein the method comprises coextruding the first or second polymeric layers.

36. A method according to claim 27, wherein providing the first polymeric layer comprises bonding a scrim to the base.

37. A method according to claim 27, wherein the first polymeric layer comprises a film.

38. A method according to claim 27, wherein the first polymeric layer comprises a tube.

39. A method according to claim 38, wherein the tube has an inner diameter, further comprising expanding the inner diameter of the tube while it is in a molten state.
